(19) United States
(12) Patent Application Publication
(10) Pub. No.: US 2025/0036982 A1
(43) Pub. Date: Jan. 30, 2025

(54) System and Method for Closed-Loop Uncertainty for Human-Machine Teamwork

(71) Applicant: The Government of the United States of America, as represented by the Secretary of the Navy, Arlington, VA (US)

(72) Inventors: Zachary A. Bishof, New Orleans, LA (US); Jaelle P. Scheuerman, Metairie, LA (US); Christopher J. Michael, Covington, LA (US)

(73) Assignee: The Government of the United States of America, as represented by the Secretary of the Navy, Arlington, VA (US)

(21) Appl. No.: 18/783,788

(22) Filed: Jul. 25, 2024

Related U.S. Application Data
(60) Provisional application No. 63/528,746, filed on Jul. 25, 2023.

(51) Int. Cl. G06N 7/01; G06N 20/00

(52) U.S. Cl. CPC G06N 7/01; G06N 20/00

(57) ABSTRACT

A method that includes receiving user input associated with identifying a threshold point associated with a classification task, identifying, a machine learning model, in the first set of visual data, a machine placement candidate point associated with identifying the threshold point, and identifying, based on the machine placement candidate point, a set of baseline confidence values via a baseline uncertainty model. The method includes training the machine learning model based on a determined state space by identifying, subsequent sets of visual data additional threshold points, receiving user feedback indicating an accuracy, comparing the baseline confidence values with locations associated with the additional threshold points, generating reward values based on an identified amount of error, and configuring the machine learning model based on the reward values. The method includes identifying in a second set of visual data, via the trained machine learning model, a visual feature associated with the classification task.

### CROSS-REFERENCE

This Application is a nonprovisional application of and claims the benefit of priority under 35 U.S.C. § 119 based on U.S. Provisional Patent Application No. 63/528,746 filed Jul. 25, 2023. The Provisional Application and all references cited herein are hereby incorporated by reference into the present disclosure in their entirety.

### FEDERALLY-SPONSORED RESEARCH AND DEVELOPMENT

The United States Government has ownership rights in this invention. Licensing inquiries may be directed to Office of Technology Transfer, US Naval Research Laboratory, Code 1004, Washington, DC 20375, USA; +1.202.767.7230; nrltechtran@us.navy.mil, referencing Navy Case #211622.

### TECHNICAL FIELD

The present disclosure is related to machine learning, and more specifically to closed-loop uncertainty and the probability of machine correctness.

### BACKGROUND

Calibrating uncertainty in online machine learning can be done by training an isotonic regression (Kuleshov, Volodymyr, Nathan Fenner, and Stefano Ermon. “Accurate uncertainties for deep learning using calibrated regression.” International conference on machine learning. PMLR, 2018) or logistic regression (Kuleshov, Volodymyr, Nathan Fenner, and Stefano Ermon. “Accurate uncertainties for deep learning using calibrated regression.” International conference on machine learning. PMLR, 2018.) model to learn the relationship between predicted confidence values and the observed accuracy of the classifier.

Concept drift can be detected using automated methods like measuring entropy (Kuleshov, Volodymyr, Nathan Fenner, and Stefano Ermon. “Accurate uncertainties for deep learning using calibrated regression.” International conference on machine learning. PMLR, 2018). This method can lead to poor uncertainty quantification until after the concept drift is detected, and calibration can occur.

Other work regarding employing reinforcement learning for calibration has relied on the usage of neural networks (Tian, Yuan, et al. “Real-time model calibration with deep reinforcement learning.” Mechanical Systems and Signal Processing 165 (2022): 108284). These methods typically need a large amount of training data, and can be less resilient in an online setting.

Human-in-the-loop reinforcement learning has been employed to achieve tasks such as automated driving (Liang, Huanghuang, et al. “Human-in-the-loop reinforcement learning.” 2017 Chinese Automation Congress (CAC). IEEE, 2017). However, these methods have often insufficiently addressed the aspect of uncertainty.

### SUMMARY

This summary is intended to introduce, in simplified form, a selection of concepts that are further described in the Detailed Description. This summary is not intended to identify key or essential features of the claimed subject matter, nor is it intended to be used as an aid in determining the scope of the claimed subject matter. Instead, it is merely presented as a brief overview of the subject matter described and claimed herein.

The present disclosure provides for a method that includes providing, by a processing device, a first set of visual data, receiving, by the processing device, user input associated with identifying a threshold point in the first set of visual data, the threshold point being associated with a classification task, and identifying, by the processing device via a machine learning model, in the first set of visual data, a machine placement candidate point associated with identifying the threshold point. The method may include identifying, based on the machine placement candidate point, a set of baseline confidence values via a baseline uncertainty model, and determining, based on the set of baseline confidence values, a state space, wherein the determining comprises determining differences between successive baseline confidences values in the set of baseline confidence values. The method may include training, by the processing device, the machine learning model based on the determined state space, wherein training comprises (i) identifying, via the machine learning model, in one or more subsequent sets of visual data additional threshold points associated with the classification task, (ii) receiving user feedback indicating an accuracy associated with each of the additional threshold points, (iii) comparing the baseline confidence values with locations associated with the additional threshold points, (iv) identifying an amount of error associated with a window of the additional threshold points, (v) generating reward values based on the identified amount of error, and (vi) configuring the machine learning model based on the generated reward values. The method may include identifying, by the processing device, via the trained machine learning model, a visual feature in a second set of visual data, the visual feature being associated with the classification task.

### BRIEF DESCRIPTION OF THE DRAWINGS

FIG. 1 illustrates an exemplary interactive machine learning paradigm coupling machine learning to a human analyst, in accordance with one or more disclosed aspects.

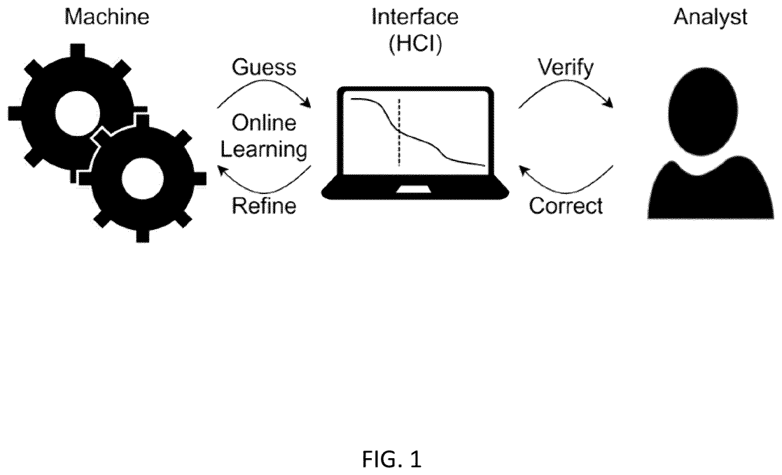

FIG. 2 illustrates an example trial phases showing the human-placed threshold and the machine-placed threshold, in accordance with one or more disclosed aspects.

FIG. 3 illustrates the forgetting integer (f) which results in the smallest average distance between the machine placement and the human placement is f=6, in accordance with one or more disclosed aspects.

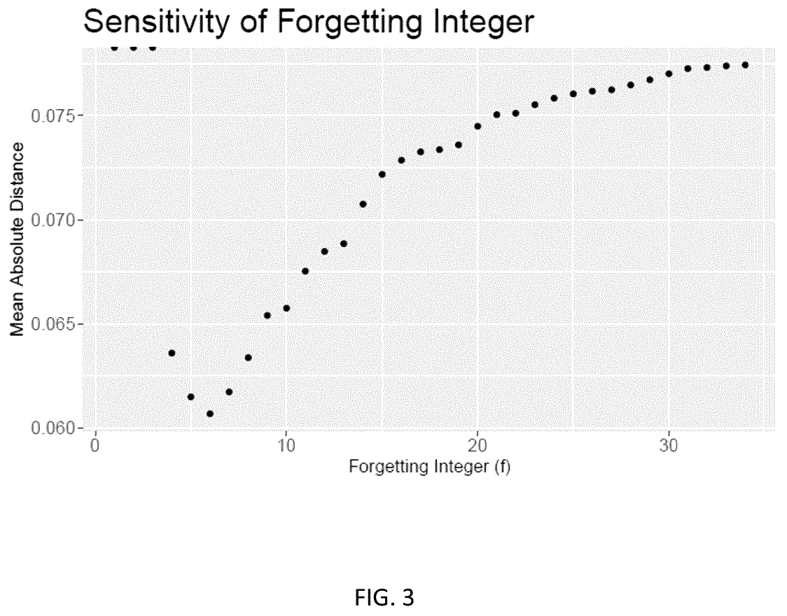

FIG. 4 illustrates an exemplary system showing architecture of a Closed-Loop Uncertainty (CLU) system, in accordance with one or more disclosed aspects.

FIG. 5 illustrates exemplary window sizes (w), where w=3 is demonstrated to be the highest performing, in accordance with one or more disclosed aspects.

FIG. 6 illustrates an exemplary state space, where a state space of size 3 performs best, in accordance with one or more disclosed aspects.

FIG. 7 illustrates exemplary performances of CLU with different action spaces, in accordance with one or more disclosed aspects.

FIG. 8 illustrates results comparing the baseline uncertainty model to the CLU model for tolerances 0.02, 0.1, and 0.2 (respectively from top to bottom), where results are plotted for each trial across all realizations, in accordance with one or more disclosed aspects.

FIG. 9 illustrates results comparing the baseline uncertainty model to the CLU model for tolerances 0.02, 0.1, and 0.2 (respectively from top to bottom), where results are plotted for each trial across all realizations, in accordance with one or more disclosed aspects.

FIG. 10 illustrates results comparing the baseline uncertainty model to the CLU model for tolerances 0.02, 0.1, and 0.2 (respectively from top to bottom), where results are plotted for each trial across all realizations, in accordance with one or more disclosed aspects.

FIG. 11 illustrates results comparing the baseline uncertainty model to the CLU model averaged across explored tolerances, in accordance with one or more disclosed aspects.

FIG. 12 illustrates results comparing the baseline uncertainty model to the CLU model averaged across explored tolerances using Kernel Density Estimation (KDE) as the baseline uncertainty model, in accordance with one or more disclosed aspects.

FIG. 13 illustrates results comparing the baseline uncertainty model to the CLU model averaged across explored tolerances using induction as the baseline uncertainty model, in accordance with one or more disclosed aspects.

FIG. 14 illustrates results comparing the baseline uncertainty model to the CLU model averaged across explored tolerances using the constant as the baseline uncertainty model, in accordance with one or more disclosed aspects.

FIG. 15 illustrates an example method in accordance with one or more disclosed aspects.

FIG. 16 illustrates an example computer system, in accordance with one or more disclosed aspects.

### DETAILED DESCRIPTION

The aspects and features of the present aspects summarized above can be embodied in various forms. The following description shows, by way of illustration, combinations and configurations in which the aspects and features can be put into practice. It is understood that the described aspects, features, and/or embodiments are merely examples, and that one skilled in the art may utilize other aspects, features, and/or embodiments or make structural and functional modifications without departing from the scope of the present disclosure.

Uncertainty is frequently used in machine learning to measure the probability of the model making an incorrect prediction of the target variable. Under concept drift, where the statistical properties of the target variable changes over time, the estimates of uncertainty become less reliable. Interactive machine learning has an advantage with the presence of a human user who may iteratively and immediately correct machine error. Disclosed aspects incorporate feedback of machine correctness into a baseline uncertainty model with a novel reinforcement-learning approach can result in better calibrated uncertainty values than provided by the baseline model.

We consider the challenge of representing uncertainty in an interactive learning system where an analyst collaborates closely with a machine learning system to validate and correct labels. Uncertainty is often not well-defined, but it is often understood to be some measure of what is unknown (Kläs, 2018). Herein it can be defined as an estimate of the probability of machine correctness, and a well calibrated uncertainty model produces uncertainty estimates that closely align with this probability.

An inaccurate uncertainty model can be either underconfident or overconfident. An overconfident model may result in misclassifications by assigning low uncertainty labels to noisy data, while an underconfident model may set a decision threshold too conservatively, leading to fewer correctly labelled positive instances. Calibrating an uncertainty model in a dynamic real world environment calls for interactive tools that build upon both the human and machine strengths to adapt to various changes in the data. Interactive learning environments provide alternative methods to handle concept drift by incorporating feedback from users who can identify changes in the environment or a drop in machine classification accuracy before the automated methods.

Disclosed aspects incorporate user feedback into the calibration of a baseline naïve Bayes uncertainty model with a novel reinforcement learning approach. Reinforcement learning allows us to frame the problem of interactive uncertainty calibration under concept drift as the goal of maximizing a reward signal (Michael Bowling, 2023). User feedback is used to create this reward signal, enabling the optimization of a policy for selecting actions that adjust the bias of the baseline model.

Previous research has linked the uncertainty model to the classification model (Jiang L., 2019), and defined uncertainty as the sample conditional error (Mingkun Li, 2006). Our approach allows for a black-box baseline model of uncertainty, which, in some embodiments, might not require a relation to the classification or knowledge about the underlying distribution of uncertainty to be known.

Disclosed aspects compare a baseline uncertainty model and one calibrated using Closed-Loop Uncertainty (CLU).

Disclosed aspects use human feedback to build a reinforcement learning model, and does not rely on detecting concept drift, which can make the model less impacted by sudden changes in the relation between the predictors and target variables.

Disclosed aspects evaluate and calibrate an uncertainty model by incorporating iterative human feedback into a novel reinforcement learning approach.

Uncertainty models in online environments are difficult to calibrate when concept drift is present. Disclosed aspects incorporate human feedback that can produce confidence values that more closely reflect accuracy and provide insight for stakeholders into the classification process.

### 1. Problem Statement

Uncertainty values reported by machine learning models do not often accurately predict the probability of model correctness. For interactive machine learning applications where curated labeled data may be scarce and data streams change modality, the conventional use of data model statistics often fall short. This may be due in large part to the absence of feedback of correctness, which is feasible for a large number of human-in-the-loop applications. In this study, we explore the potential of incorporating such feedback into an interactive machine learning model for a threshold selection problem. The problem involves a user subjectively selecting the point at which they consider a signal to transition to a low state without providing specific rules to the user for what constitutes a low state. The classifier-driven machine model will attempt to mimic the analyst's selection, with the signal becoming more complex in time.

Disclosed embodiments provide for systems and methods for evaluating uncertainty, which can be defined as the probability of machine correctness, and used to compare a baseline model using naive Bayes with a novel reinforcement learning approach. The novel approach refines a black-box model for uncertainty by incorporating machine performance as feedback. Experiments are conducted over a large number of realizations in order to properly evaluate uncertainty using a stochastic process.

Results show that our novel approach, called closed-loop uncertainty (CLU), outperforms the baseline in every case, yielding about 46% improvement over the baseline on average.

In addition, we evaluate a Kernel Density Estimation (KDE) naive Bayes model, an induction model, and a constant model as the black-box model to test the performance of CLU.

### 2. Introduction

The concept of uncertainty is used with great frequency in machine learning (ML) to give an understanding of the dependability of model classifications and predictions. However, uncertainty is interpreted and used in many different ways when applying ML models. It is used to evaluate the reliability of the ML (Abdar et al., 2021; Jiang et al., 2018), to optimize ML, (Sahinidis, 2004), and to provide transparency to stakeholders about the ML (Bhatt et al., 2021).

In active learning, uncertainty reduction is a vital component where uncertainty establishes a basis in deciding what examples to query the user for labeling to maximize the precision in a data stream (Aggarwal et al., 2014; Hüllermeier and Waegeman, 2021). Interactive machine learning (IML) involves tightly coupled ongoing interactions between an ML algorithm and a human via a constrained human-computer interface (Mosqueira-Rey et al., 2022). IML implementations utilize a human-machine team that cooperate to iteratively solve a problem. As such, it is useful to define uncertainty as the probability that a machine's attempt to solve a problem is incorrect (Monarch, 2021; Michael et al., 2019). When defined in this way, uncertainty can be used to manage cognitive load on the user by maintaining balance between exploration and exploitation. In theory, ML models that have a statistically viable sampling of data may yield accurate values of uncertainty solely based on the distribution of this sampling under a robust data model. However, many problems either do not attain this sampling or suffer from concept drift, a modality change in data context that interrupts or invalidates the data model (Schlimmer and Granger, 1986). This modality change makes it likely that the data model's yielded uncertainty is low while classification accuracy is also low, which is indicative of an uncertainty model that does not properly reflect the probability of machine correctness. The opposite may also be true, where a yielded high uncertainty is reported during events of high accuracy. This tends to occur during classifier warm-up or when data models are underfit.

A major advantage of the IML paradigm is the presence of a human user who may iteratively and immediately correct machine error. In some cases, this human feedback may be available immediately to refine a supervised data model by training online on user-corrected information treated as ground truth. Though this technique is trivial for the precision of the ML model's classification or prediction, very little work has focused on incorporating such feedback to improve the way in which uncertainty is quantified (Michael et al., 2020; Monarch, 2021).

Disclosed aspects provide a better understanding of how uncertainty is improved and evaluated for IML applications.

A methodology for experimentation that takes iterative feedback of machine correctness into account is presented. To introduce the underlying concepts, a somewhat subjective and generative thresholding task is defined and used as a target problem for experimentation. This task involves a human analyst selecting the point at which a decaying signal, namely a sigmoid, is to be considered “low” on a visual plot. As the task progresses, the signals enter new stages of modality to simulate concept drift. At every step, the machine's goal is to place the threshold within an accepted tolerance to the analyst's placement. The machine begins the task at cold start, meaning with no prior training data, and trains on the human placement using a supervised model. Additionally, and most importantly for our case, the machine will also provide a probability that this placement is correct.

The presented methodology for evaluation examines the machine's reported uncertainty over many independent realizations of the task in order to compare it to a more accurate measurement of the probability of correctness. Statistics are gathered at every step across all realizations to evaluate the performance of the uncertainty model. We present and compare two supervised models for uncertainty using the presented methodology: A baseline that implements a conventional data-model approach using naive Bayes and a novel approach using reinforcement learning to adjust the bias of the baseline using feedback of machine correctness. We name the novel approach the closed-loop uncertainty (CLU) model because it takes into account machine correctness in an online and iterative manner.

### 3. Related Work

The discussion and formulation of uncertainty is an extensive topic in ML literature. The majority of prior work discussed in this section mainly focuses on studies that present methods for calculating some value of uncertainty based on the distribution of example data. Studies involving uncertainty values that are provided explicitly by humans for example data during training are considered out of the scope of this study. We do not know of any study that feeds back correctness to improve uncertainty modeling as a probability of machine correctness. The interpretation of confidence, which we define to be the opposite of uncertainty, by Pronk et al. (2005) for the naive Bayes classifier formulates the confidence interval for the posterior probabilities of classes. The CLU model we present contrasts to this approach in that it takes posterior probabilities as an observable state rather than an estimate for classification confidence.

Defining uncertainty as the probability that a model is incorrect (or confidence as the probability that a model is correct) is useful for evaluating trust in a model or metering the cognitive load and human interaction. However, this definition does have limitations when compared to other discussions in literature. One limitation is that it fails to distinguish between aleatoric uncertainty and epistemic uncertainty (Hullermeier and Waegeman, 2021; Hora, 1996). Aleatoric uncertainty involves the distribution of noise and other randomness within the data, while epistemic uncertainty addresses the lack of knowledge within the ML model. Aleatoric uncertainty is difficult to measure (Wang et al., 2019), especially under concept drift (Lu et al., 2020). Other studies more aligned with our approach have defined uncertainty as a measurement of what is not known at the time of classification (Kläs and Vollmer, 2018). Though this definition allows considerably more leeway, we choose a probabilistic interpretation that allows us to validate models for uncertainty experimentally within an IML paradigm.

Though much of ML theory models classification and prediction on the basis of statistical probability, general formulation and evaluation of uncertainty is known to be considered something of an afterthought (Kläs and Vollmer, 2018). The general idea behind most models of uncertainty is a mathematical basis for the data model. For example, the softmax layer in a neural network gives a score that may indicate a lack of knowledge about a classification for multi-classification problems (Jiang et al., 2018). However, many times such models demonstrate some sort of best fit to the probabilities of a label in training data rather than a logical measurement of machine knowledge about a specific class (Kaplan et al., 2018). Additionally, these models are often not well calibrated or may not adequately reflect the probability of the machine to be incorrect after calibration (Guo et al., 2017). In these cases, a classification with a low uncertainty does not necessarily imply a high accuracy (Provost et al., 1998). For streaming problems, these shortcomings of conventional ML models for uncertainty are exacerbated in the presence of concept drift where data modalities in the stream may change abruptly and/or unexpectedly (Lu et al., 2020). Therefore, it may be worthwhile to consider if an interpretation of uncertainty that departs from stringent mathematical definitions for the data model would be practical in providing a more accurate quantification of uncertainty, especially in situations where sampling is low or concept drift is expected to occur.

Mathematical frameworks for estimating uncertainty have been explored in the context of neural networks for image processing (Wang et al., 2019). These techniques use variance and entropy of a statistical distribution to measure uncertainty, which could also aid in detecting concept drift (Du et al., 2014). Our CLU model differs from these techniques in that it does not explicitly detect concept drift or variance in input feature data. Rather, CLU only observes some measurement of uncertainty, namely the posterior probabilities of a black-box classifier, and adjusts its bias based on the observed accuracy of the machine. Therefore, the goal of our work is not to detect concept drift, but to provide a model of uncertainty that is adaptable to concept drift when the drift causes bias in the underlying model. The CLU model presented in this study uses a feedback model to yield an improved quantification of uncertainty, and this value may have a higher order uncertainty associated with it. Such phenomena for reinforcement learning have been discussed thoroughly in Clements et al. (2020), where the difference between aleatoric and epistemic uncertainty is distinguished within deep reinforcement learning.

The study builds on previous work that aims to view uncertainty through the lens of a return distribution and the variance associated with it (Nikolov et al., 2018; Bellemare et al., 2017). These previous studies in reinforcement learning have defined uncertainty as a function of the input data or lack of input data, while the CLU implementation that we present defines uncertainty as a function of the accuracy of the underlying classification model within a stochastic process where accuracies may be measured.

IML models have calculated uncertainty using mixture models or some approach that resembles that of the machine learning algorithm used in the classification process (Jiang et al., 2019). In other studies, uncertainty has been defined as the sample conditional error, which is the probability that the classifier makes a mistake on a given sample (Li and Sethi, 2006; Teso and Vergari, 2022). These techniques require that the underlying distributions of the data model are known, which is often not possible. Our approach allows for a black-box baseline model of uncertainty, and we show that it performs accurately even when the data-model distributions are not accurate.

### 4. Background

The notation [[a, b]] is used to signify the set of integers from a to b, that is [[a, b]]={a, a +1, . . . , b−1, b} where a, b∈I; while the traditional notation [a, b] refers to the continuous inclusive set of real numbers from a to b. A sigmoid curve, or logistic curve, is an S-shaped curve. For our setting, we are interested in a version that begins at near y=1 and decays to approach y=0, as well as being centered somewhere between x=0.2 and x =0.8. In general, we can describe this curve using the following

$$y ( x ) = \frac{1}{1 + {e}^{k ( x - {x}_{0} )}} \qquad ( 1 )$$

where x₀ is the curves midpoint and k is the decay rate. Gaussian naive Bayes classification is used as a baseline, which operates by calculating posterior probabilities assuming all predictor covariates have a normal distribution and are independent. (Zhang, 2004) Kernel Density Estimation (KDE) can be used to estimate the distribution of a covariate. It is useful in the sense that it can help deal with the problems posed by continuous variables.

If some of the features can be described as continuous and some can be described as discrete, then assuming they all come from the same distribution is not valid. KDE allows for the smoothing of the distributions of the feature space.(John and Langley, 2013)

A Markov Decision Process (MDP) is defined as a tuple (S, A, T, R, γ), which contains a state space S, a set of possible actions A, a transition probability matrix T, a reward function R, and a discounting factor γ. (Sutton and Barto, 1998)

Q-Learning is a type of model-free RL that can be used to find the optimal policy, the strategy for choosing actions in each state, by updating the expected reward for state action pairs. The only conditions for convergence on the optimal policy is that the actions are repeatedly sampled in all states, and the action-values are discrete (Watkins and Dayan, 1992). This is advantageous for our problem, because it allows us to approach the optimal policy simply by randomly choosing actions for each trial. Q-Learning is a popular implementation of RL due to its simplicity and effectiveness at finding optimal solutions in MDPs. In experience replay, instead of updating the expected reward for state-action pairs as they appear in simulation, there are stored data. There is a set of past experiences which depict the states, actions, rewards, and next states. This means that the learning is separate from the experience, and all interactions with the environment are stored.

### 4.1. Index of Terms

Uncertainty—A measure of what we don't know about the classification. In a practical sense, the probability that the classifier algorithm makes an incorrect classification.

Confidence—The opposite of uncertainty. Confidence=1−Uncertainty

Accuracy—The fraction of correct classifications over total classifications.

Sample Points—100 points on a trial graph, evenly spaced along the x-axis, which together depict a sigmoid curve.

Trial—An individual graph where the analyst has made a selection of the correct location of a human placed threshold. Also included is all of the data that comes from this graph and selection.

Phase—A round of seven trials for which the concept drift is held conceptually fixed. For example, in the first phase only square waves are displayed, the second phase only displays logistic curves, and the third phase shows random noise at random selected points.

Realization—A complete run of the experiment, which contains 35 trials and 5 total phases. In total 30 realizations were performed.

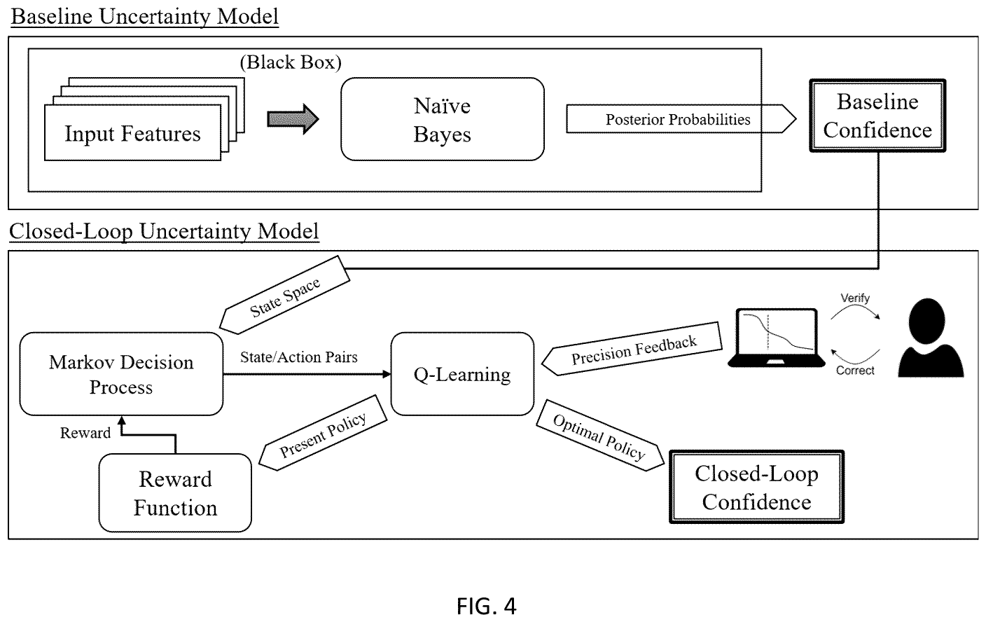

Baseline Uncertainty Model—The model that measures uncertainty using conventional approaches rooted in naive Bayes. This is the model that is built upon by feeding into CLU. We can think of this as the schematic diagram displayed in FIG. 4.

Performance—How well the confidence values from the uncertainty model matches the probability of correctness, which can be measured with the distance between the accuracy and the average confidence values produced. Human Placed Threshold—The location of the threshold on the graph that the analyst chooses to be where the sigmoid curve signal is no longer considered high. Machine Placed Threshold—The location that the classifier algorithm predicts is the location of the human placed threshold. Tolerance (T)—A parameter representing the maximum distance, with respect to the horizontal, that a machine placed threshold can be from the human placed threshold for the classification to be considered correct.

Optimal Policy—At any given step or trial in the realization, the policy that chooses the action associated with the maximum available action value function.

Present Policy—A modification on the optimal policy at a specific step or trial in the realization. The state associated with the trial is given a random action, and this state action pair is swapped into the optimal policy. All other state action pairs stay the same.

### 5. Threshold Selection Problem

The methodology for uncertainty presented in this study is specific to an online IML implementation (Fails and Olsen Jr, 2003). Though a multitude of problems for which IML implementations exist are available in the current state of the art, the problems either possess overly complex features and interfaces or do not provide controls to induce concept drift in a stochastic manner. We present a threshold selection problem that exhibits the properties of being an intuitive task definition with a simple interface, a 2-dimensional dataset with a minimal feature space, a stochastic basis for generating a very large number of 2D examples for the problem space, moderate subjectivity that prevents trivial solutions without human interaction, and a parameterized complexity and noise model used to induce concept drift.

This threshold selection problem is a simpler surrogate for online IML applications in the sense that it exhibits subjectivity in preference and concept drift, similar to those discussed by Kabra et al. (2013) and Michael et al. (2019). This is all while being simpler to form into a stochastic process by which we can study uncertainty as a probability of correctness. The problem is able to be realized such that a single trial of the problem will be, for the most part, similar in complexity across all realizations. This property is useful for the methodology of evaluating uncertainty as a probability of correctness.

### 5.1. Trial Definition

The decaying sigmoid curve used for generating example is a type of logistic function that begins at near y=1, decays to approach y=0, and is centered somewhere between x=0.2 and x=0.8. In general, the curve may be described using the following function:

$$\vert y ( x ) = \frac{1}{1 + {e}^{k ( x - {x}_{0} )}} \qquad ( 2 )$$

where x0∈[0.2, 0.8] is the curve's midpoint and k is the decay rate. A trial consists of a 2D plot of a decaying sigmoid curve sampled at 100 regular discrete points. The user is asked to locate the point at which they think the sigmoid transitions from a high state to a low state, i.e. the human-placed threshold, which is treated as ground truth.

### 5.2. Phase Definition

In a realization of the problem, multiple trials will be generated and presented to the human-machine team in a particular order. A phase is a consecutive subset of trials with similar stochastic parameterization, which defines a set modality of complexity. Overall, the progression of phases are intended to induce some new form of complexity to the sigmoid. Phase I will only contain trials that are square waves. This phase is the simplest phase and the only phase that leaves little room for subjectivity. The only stochastic parameter is the center of the plot, x0∈[0.2, 0.8], which is selected in a uniform random way. The curve depicted for the analyst in each trial for phase I is

$$y ( x ) = \{ \begin{matrix}1 & if x \leq {x}_{0} \\ 0 & if x > {x}_{0}\end{matrix} \qquad ( 3 )$$

Phase II depicts a logistic curve where the decay rate is randomly assigned, leading to a faster or slower decay:

$$k = {( 1 - \frac{1}{1 + exp ( \frac{- 1}{1 - d} )} )}^{- 1} \qquad ( 4 )$$

where d∈[0, 1) is a uniform random variable. This formula was found to yield the best mix of sigmoid decay after experimenting with a variety of other approaches. The subsequent phases, III-V, induce random noise throughout the sigmoid. The noise N is applied in an additive way. The magnitude of the noise N=mcos(Tπ), where T∈[0, 1] and m∈[0, 0.8] are uniform random variables. The variable m indicates the maximum magnitude of additive noise such that N∈[−m, m]. Trials of Phase III generate sigmoids with N added to a uniformly random percentage of uniformly random chosen points. Phase IV generates sigmoids with N added to randomly chosen subintervals of points. Subinterval sizes are chosen by the uniform random variable 1∈[0, 100]. The number of subintervals is randomly chosen from the set {0,1, . . . , └100/l┘}. Finally, Phase V sigmoids contain additive noise, N, throughout the entire function. Any phase may theoretically generate a plot from a previous phase depending on the parameters and noise.

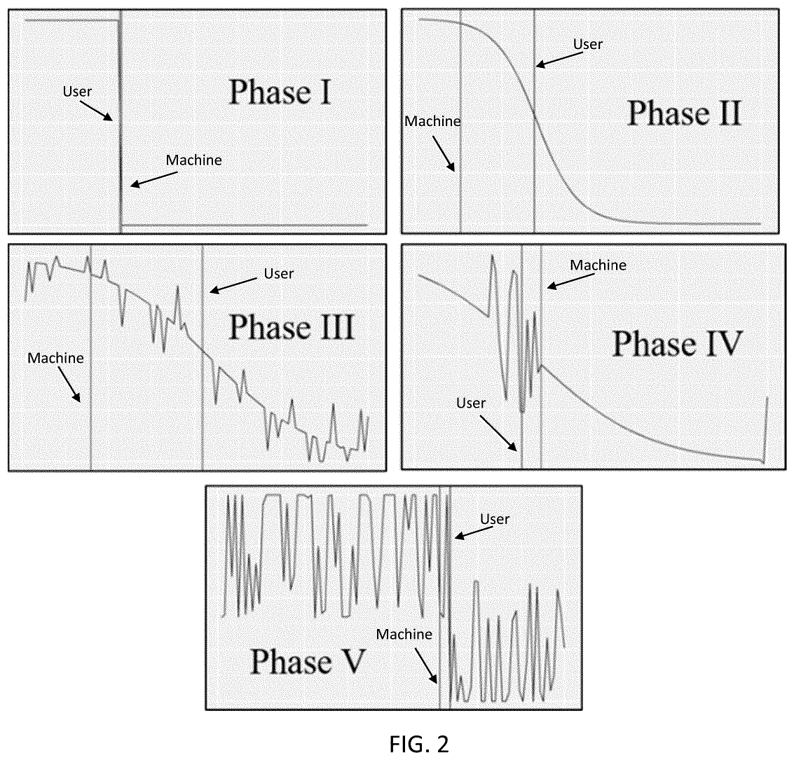

An example of a trial from each phase is shown by the plot in FIG. 2. The examples shows both the human-placed threshold in blue, which is considered ground truth, and a machine-placed threshold in red, which is placed algorithmically based on a naive Bayes classifier. As will be discussed in Section 6.1, the methodology allows for different tolerances for machine-placed thresholds to be considered as correct placements.

### 6. Machine Models

### 6.1. Naive Bayes Classifier

A Gaussian naïve Bayes classifier is used to predict the location of the human placed threshold. We refer to this predicted threshold as the machine-placed threshold, which is shown as the red lines of the example plots in FIG. 2. The features used by the naive Bayes classifier include the basic coordinates of each trial's sigmoid. In addition, several features are extracted to enhance the feature space. This includes the first derivative of the sigmoid at each discrete point, the second derivative of the sigmoid at each point, the mean of the next 10 point's y values, and the mean of each point along with its 2 direct neighbors. These features were determined using conventional feature selection techniques, and they were shown to yield generally high accuracy in each phase after warm up for reasonable tolerances of machine placement.

Labels are determined by assigning 1 to all sample points with x-coordinates less than or equal to the human placed threshold and 0 to all sample points with x-coordinates greater than the human placed threshold. This labeling scheme worked best for machine placement when compared to other schemes, mainly due to its relatively balanced positive and negative labels when training. The location of the machine placement was chosen at the first point with the mean of the posterior probability (generated from Gaussian naive Bayes) and that of its two direct neighbors being greater than 0.55.

For FIG. 2, correct machine placement can be determined by the tolerance, where a tolerance of 0.04 would mark the Phase I and V examples correct and all others incorrect. A tolerance of 0.06 would allow for the Phase IV example to be marked for correct machine placement.

### 6.2. Baseline Uncertainty Model

A baseline uncertainty model is used to produce first-order input uncertainty values for CLU. Disclosed aspects utilize a more conventional uncertainty model based very heavily on the naive Bayes classifier of the previous section and is used for experimentation. This is referred to as a baseline uncertainty model mainly because it resembles a natural choice for an uncertainty model in the current state of the art; that is, one that does not iteratively take feedback of correctness into account. Unlike the model for machine placement, the uncertainty model must account for some placement tolerance, denoted by the variable T, allowed by the application. The placement tolerance is an independent variable that determines the distance within which a machine placement must be from a human placement to be considered correct. The lower the placement tolerance, the lower the expected placement accuracy, and vice versa.

In labeling a trial for the uncertainty model, all sample points within the distance of the placement tolerance are labeled as 1, and all other points as 0. A Gaussian naive Bayes classifier is trained with this information. Using this model, the posterior probability that a sample point in a trial should be given a label of 1 may be calculated. A confidence (recall confidence=1−uncertainty) can then be generated from this value by taking the average of all these probabilities within the placement tolerance of the machine-placed threshold. Other than labeling, the baseline uncertainty model differs from the naive Bayes classifier in two other ways. First, we found during experimentation that instance forgetting does not yield a more accurate value of uncertainty, so the baseline model does not implement forgetting. The second difference is that the baseline's technique for labeling generates a very large amount of bias for certain features, namely the first and second derivative features, which was found through feature selection analysis. Therefore, the baseline uncertainty model uses the same input feature set as the naive Bayes classifier except for the first and second derivative features.

6.3. Closed-Loop Uncertainty Disclosed embodiments provide for the generation, construction, or development of the components of a Markov Decision Process (MDP) and a method for policy selection. This was done using the uncertainty values from the baseline uncertainty model and feedback from the user indicating machine correctness. Disclosed embodiments define the Markov Decision Process and the policy selection. The size of the state space, action space, and the window parameter in the reward function were studied using a sensitivity analysis described in section 6.5.

### 6.3.1. STATE SPACE

We define the state space S={1, 2, 3} by taking a discretization of the difference between successive confidence values

$$Δ {C}_{t} = {C}_{t} - {C}_{t - 1} \qquad ( 5 )$$

where t indicates the trial number, generated by the baseline model within any realization. This is done by dividing the interval [−1, 1] into three equal sized sets. For example, if trial number 7 gives a confidence of 0.9, and trial number 8 gives a confidence of 0.6, then ΔC8 would be −0.3, and trial number 8 would be in state 2. We do a discretization in this way, because the state space is required to be discrete to guarantee convergence on the optimal policy (described in section 6.3.6). Conventional discretization techniques resemble this approach (Hasselt, 2012).

$${S}_{t} ( Δ {C}_{t} ) = \{ \begin{matrix}1 & if Δ {C}_{t} ∈ [ - 1 , - 0. \overline{33} ) \\ 2 & if Δ {C}_{t} ∈ [ - 0. \overline{33} , 0. \overline{33} ) \\ 3 & if Δ {C}_{t} ∈ [ 0. \overline{33} , 1 ]\end{matrix} \qquad ( 6 )$$

According to some aspects, the state space (S) can be described as: Current states are found by taking a discretization of the difference between successive confidence values. At each trial t, the difference in confidence is ΔC_t=C_t−C_{t−1}, and the current state S_t (ΔC_t )=[(σ−1)/2 ΔC t+(σ+1)/2] where σ is the number of possible states. A sensitivity analysis was conducted and found a state space size of 3 resulted in the best performance.

### 6.3.2. Action Space

The set of possible actions

$$A = \{ - 1 , - 0.95 , 0.9 , … , 0.95 , 1 \} \qquad ( 7 )$$

is defined by evenly discritizing the interval [−1, 1] into 41 values. This definition allows for a fractional shift on any given state's confidence value either up or down. For example, an action of 0.5 can be thought as the act of making a 50% gain of any given state's confidence value towards 1, while the action −0.5 would cause a 50% loss towards zero. More formally, given an action At and a confidence value Ct, we can find the confidence value that is the result of an action C′t (At,Ct), by using the following equation:

$${C}_{t}^{′} ( {A}_{t} , {C}_{t} ) = \{ \begin{matrix}{C}_{t} + {A}_{t} {C}_{t} & if A \leq 0 \\ {C}_{t} + {A}_{t} ( 1 - {C}_{t} ) & if A > 0\end{matrix} \qquad ( 8 )$$

The action space (A): Actions indicate a fractional shift on any given state-s confidence value either up or down. The set of possible actions is A={x ∈ [symbol] −1x≤1≤, x=2b, a−1, b∈ [symbol] , α∈2 [symbol] +1}, where α is the number of possible actions, and is set to 15 as a result of sensitivity analysis. Given an action Aₜ and a confidence value Cₜ, the confidence values that is the result of an action is Cₜ′(Aₜ, Cₜ)={Cₜ+AₜCt, Aₜ≤0 Cₜ+Aₜ(1−Cₜ), Aₜ>0

### 6.3.3. State Transitions

Previously we defined ΔCₜ′ as the difference between successive baseline confidence values, and this was used to define the state space, We now must define Sₜ′ that is the state that is transitioned to from Sₜ as a result of action Aₜ. Let

$$Δ {C}_{t}^{′} = {C}_{t}^{′} - {C}_{t - 1} \qquad ( 9 )$$

It should be noted that ΔCₜ′≠Cₜ′−Cₜ₋₁′. Sₜ′ reflects the state that occurs under the change to the bias from action Aₜ. For this reason, we replace the first term from equation 5 with the result from equation 8

The new state Sₜ′, not to be confused with Sₜ₊₁, is calculated using equation 6, and thus becomes Sₜ′=S(ΔCₜ′).

According to some aspects, the state transitions (S′) can be described as: Let Sₜ′ be the state reached from Sₜ as a result of action Aₜ, and ΔCₜ′=Cₜ′−C_{{t-1}}, then Sₜ′=S(ΔCₜ′).

### 6.3.4. Transition Probabilities

The transition probabilities T are not needed to be known, as we are dealing with model-free reinforcement learning. (Sutton and Barto, 1998)

### 6.3.5. Reward Function

For CLU, an ideal reward function would give a higher reward when the policy is choosing actions that tune the bias of the confidence in the direction of the probability of a correct classification. For this reason, the reward function uses an estimate of the error between the confidence of the baseline model and that of the accuracy of the machine placement.

Define accuracy pₜ at trial t to be equal to either 1 when the machine placement is correct, i.e. when the machine placement is within a tolerance of the human placement, or 0 when the machine placement is incorrect. The mean streaming accuracy, is defined as

$$\overline{{p}_{t}} = {min ( w , t )}^{- 1} {\sum }_{i = max ( 1 , t - w - 1 )}^{t - 1} {p}_{i} \qquad ( 10 )$$

Where the window size w is set equal to 3 (see 6.5.1). Note that p̅t is only used (and defined) for t>1. Given a present policy πₜ (which will be defined in equation 15) at trial t, a state Sₜ, and a window size w, the window mean squared error, which estimates the discrepancy between machine placement accuracy and baseline confidence values, is defined as

$$\vert {D}_{t}^{′} = {min ( w , t - 1 )}^{- 1} {\sum }_{i = max ( 1 , t - w - 1 )}^{t - 1} {( {C}_{i}^{′} ( {π}_{i} ( {S}_{i} ) , {C}_{i} ) - \overline{{p}_{t}} )}^{2} \qquad ( 11 )$$

For the baseline confidences, i.e. the policy π(s) 0 for all s, meaning that Cₜ′=Cₜ every t, the baseline, window mean squared error Dₜ is

$${d}_{T} = {min ( w , t )}^{- 1} {\sum }_{i = max ( 1 , t - w - 1 )}^{t - 1} {( {C}_{i} - \overline{{p}_{t}} )}^{2} \qquad ( 12 )$$

These are used to calculate Rₜ for transitioning from state Sₜ to Sₜ′ due to action Aₜ.

$${R}_{t} = \{ \begin{matrix}1 - {D}_{t}^{′} & {D}_{t}^{′} < {D}_{t} \\ - {D}_{t}^{′} & {D}_{t}^{′} \geq {D}_{t}\end{matrix} \qquad ( 13 )$$

Note that a each trial t, Dₜ′ depends on not only the mean streaming precision p̅ₜ, the present policy at each trial. This present policy is used to define Cₜ′ for all trials in a given window Wₜ, i.e. trials t∈Wₜ=:[[max(1t−w−1),t−1]]. These value for Cₜ′ inside each window depend on the states and baseline confidences for each trial inside Wₜ, yielding a unique Rₜ.

The reward function (R): The reward values at each trial t are found by measuring estimated calibration within a window of recent trials. Given a window Wt={i∈N: max(1, t−w−1)≤i≤t−1}, where the window size w is set to 24 as a result of a sensitivity analysis, the mean streaming accuracy is p̅ₜ=min(w, t)⁻¹ Σwₜpᵢ, where pᵢ equals 1 at each trial where machine placement is correct and 0 otherwise. Given a present policy πₜ and a state Sₜ, the window mean squared error Dₜ′=min(w, t)⁻¹ Σwₜ(Cᵢ′(πᵢ(Sᵢ), Cᵢ)−p̅ₜ)² and the baseline window mean squared error Dₜ=min(w, t)⁻¹ Σwₜ(Cᵢ−pₜ)². Using all of this, the reward function Rₜ={1−Dₜ′, Dₜ′<Dₜ−Dₜ′, Dₜ′≤Dₜ

### 6.3.6. Policy Selection

At any trial, all of the previous trials' states and black-box output confidences are stored and actions are randomly assigned to each trial. This forms a basis for the online Q-learning model. The action-value function Q(S,A) gives the expected reward for each state under each action. The learning is defined in the typical way for Q-learning (see 6.4) where the discount factor and learning rate are both set to 0.1.

Given a state s, the optimal policy π* yields the action that produces the highest q-value. If all q-values are either negative or zero, then the optimal policy is to take action “0”.

$${π}_{*} ( s ) = \{ \begin{matrix}arg {max}_{a} Q ( s , a ) & ∃ a ∈ A s . t . Q ( s , a ) > 0 \\ 0 & otherwise\end{matrix} \qquad ( 14 )$$

Given a state Sₜ and randomly chosen action Aₜ at trial t, the present policy, πₜ, optimal action π_{*}(Sₜ) with Aₜ:

$${π}_{t} ( s ) = \{ \begin{matrix}{A}_{t} & s = {S}_{t} \\ {π}_{*} ( s ) & s \neq {S}_{t}\end{matrix} \qquad ( 15 )$$

The present policy was used to determine reward values.

The optimal policy at each trial is used to calculate the confidence values as shown in FIG. 4.

Policy selection: The optimal policy π* is found using Q-learning (Sutton & Barto, 1992), and the present policy πₜ(s)={Aₜ, s=Sₜ π_{*}(s), s≠S_t. At each trial, the optimal policy is used to calibrate uncertainty values, and the present policy is used in the reward function.

### 6.3.7. Experience Replay

Experiences eₜ=(Sₜ, Aₜ, Rₜ, Sₜ₊₁) were stored in a dataset, which are then replayed to the agent. This technique allowed us to conduct and store the data from several realizations. This permitted us to conduct all of our model building after conducting the 30 realizations, because it allowed us to compare a wide variety of definitions of the MDP and evaluate results by trial across realizations.

### 6.4. The Choice to Use Q-Learning

As described in section 6.3.7, it was necessary to use experience replay in our experiment. As a result, it is necessary to learn using off-policy techniques. As a result, Q-learning was a logical choice, because Q-learning operates off-policy (Mnih et al., 2013). This choice was made as opposed to something like SARSA where actions are chosen based off the current policy.

The learning rule for Q-learning is defined at each trial t as

$$Q ( {S}_{t} , {A}_{t} ) ← Q ( {S}_{t} , {A}_{t} ) + λ ( {R}_{t} + γ {max}_{a} Q ( {S}_{t}^{′} , a ) - Q ( {S}_{t} , {A}_{t} ) ) \qquad ( 16 )$$

where γ, λ∈[0, 1] are the discount factor and learning rate respectively. We had both of these set to 0.1.

### 6.5. Sensitivity Analysis

Throughout the process of defining the MDP, several decisions had to be made regarding the value of key parameters. There was the window size w for the reward function presented in section 6.3.5, the size of the state space (which determines the size of the intervals in equation 6), and the number of available actions (which determines the members of the set in equation 7).

In order to make these selections, sensitivity analyses were conducted. The approach, for each of these parameters, was to hold all other parameters fixed and to run the experiment for a large set of the parameter in question. Then, results were collected using equation 19. The parameter value with the highest 1−MAE, across all trials and realizations, was then chosen.

### 6.5.1. Window Size for Reward Function

The window size w was the first parameter that was cycled through, with all other parameters held fixed. Arbitrarily, the size of the state space was held fixed at 3 and the number of possible actions was held fixed at 9. In all, the values tested were w∈[[2, 25]].

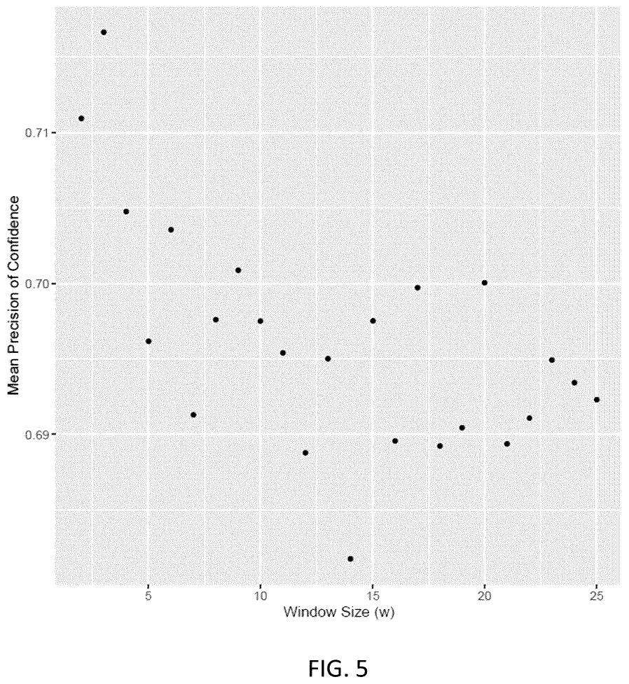

We can see from FIG. 5 that the window size that resulted in the best performance was w =3. That being said, there was not a major difference between highest and lowest performing window sizes (note the y-axis in FIG. 5). This leads us to conclude that, although the window size is important, small changes in the window size do not result in large changes in the overall performance of CLU.

### 6.5.2. Size of the State Space

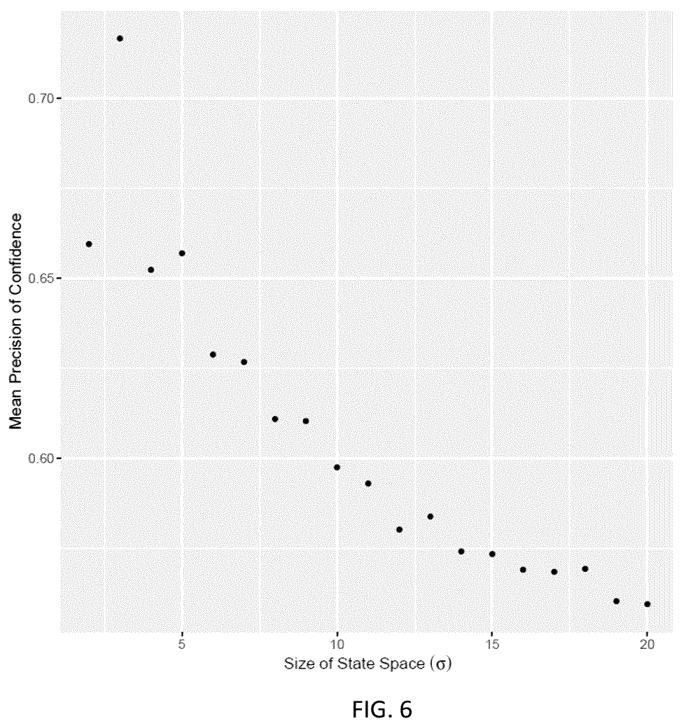

As the state space size was tuned, the intervals that, if containing ΔCt, determine St must cover [−1, 1]. Therefore the general definition of the state space is

$${S}_{t} ( Δ {C}_{t} ) = \{ \begin{matrix}1 & if Δ {C}_{t} ∈ [ - 1 , - 1 + \frac{2}{σ} ) \\ 2 & if Δ {C}_{t} ∈ [ - 1 + \frac{2}{σ} , - 1 + \frac{4}{σ} ) \\ ⋮ & \\ σ & if Δ {C}_{t} ∈ [ - 1 + \frac{2 ( σ - 1 )}{σ} , 1 ]\end{matrix} . \qquad ( 17 )$$

where σ∈N is the number of states. In FIG. 6, a smaller state space is shown to outperform a larger state space, with a peak performance at size 3. One of the causes for this might be that a larger state space needs more time to explore, and would never be fully utilized in the limited 35 trials for each realization. Recall that one of the conditions for the convergence of Q-learning is that all actions are repeatedly sampled in all states (Watkins and Dayan, 1992). A caveat to this general principle of a smaller state space working better is that a state space of size 3 seemed to outperform a state space of size 2. A state space of size 2 sets all negative ΔCt in state 1 and all positive ΔCt in state 2. The downside to this definition is that ΔCt that is near 0 could end up in either state. This means that for any value of ΔCt that is near zero, which was quite common, a small change would result in a potentially large change in the policy. As a result, a state space of size 3 works better, because now the three possible states can be thought of as 1: a significant negative decrease in successive confidence values, 2: no significant change in successive confidence values, and 3: a significant increase in successive confidence values. It can also be deduced from FIG. 6 that CLU is sensitive to the size of the state space. This means that any implementations of CLU should take great care in the choice for the state space.

### 6.5.3. Action Space Size

As the action space was altered, the set of possible actions is

$$A = \{ - 1 , \frac{3 - α}{α - 1} , \frac{5 - α}{α - 1} , … , 1 \} \qquad ( 18 )$$

where α∈2N+1 is the number of possible actions. α was required to be an odd number greater than or equal to 3, so that an action of 0 (i.e., the action that does nothing) was always possible, and every positive action had an equivalent negative action.

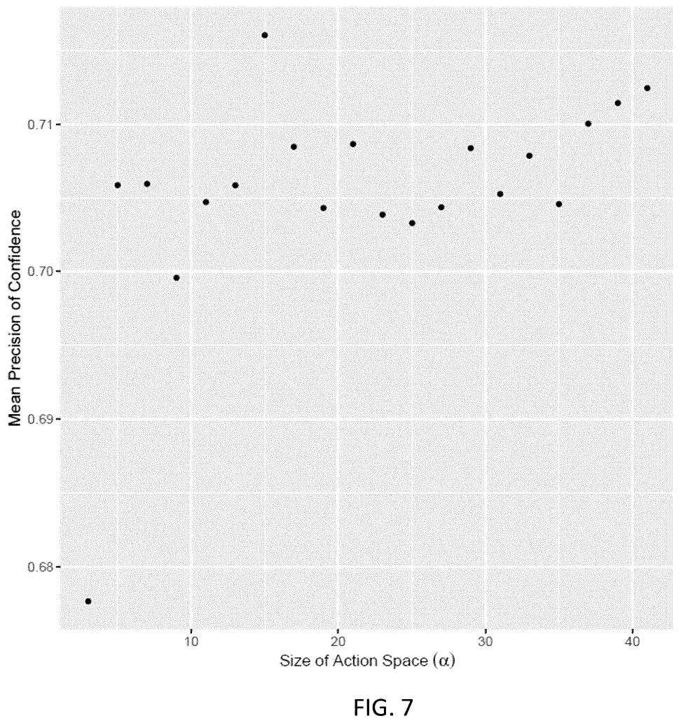

In FIG. 7, it appears that the choice of a does not seem to alter the performance of CLU. Note that, for alpha >3, the worst performing a and the best performing α do not result in much difference in overall performance. This tells us that CLU is not highly sensitive to the size of the action space. In FIG. 7, there is an initial noisy period and then around α=23, there appears to be convergence. As such, we choose the highest performing action space size to be α=41.

### 7. Methodology and Experimentation

In order to evaluate uncertainty as a probability of incorrectness, the methodology for experimentation must be formed as a stochastic process. Judging an uncertainty model based on a single realization of an experiment is likened to evaluating the fairness of a coin based on a single flip. Therefore, the presented experimental methodology for evaluating uncertainty is based on many parallel realizations of the experiment that are evaluated at every trial t. Preferences from user to user are not expected to be similar for phases other than Phase I, but each user's preference is expected to be consistent within a realization.

Results are reported using one minus the mean absolute error (MAE) at each trial t across all realizations:

$$PoC ( t ) = 1 - MAE ( t ) = 1 - \frac{1}{n ( {C}_{t} )} {\sum }_{{c}_{i} ∈ {C}_{t}} \vert {P}_{t} - {c}_{i} \vert a \qquad ( 19 )$$

where Ct is a set containing confidences at trial t across all realizations, n(Ct) represents the number of realizations in Ct, and Pt is the accuracy of machine placement at trial t across all realizations. The subtractions from 1 is done so as to have higher values represent a better performing model. Sometimes we refer to 1−MAE as precision of confidence or PoC.

Experiments were conducted for 30 realizations, each realization consisting of the 5 phases described in Section 5.2, each with 7 trials for a total of 35 trials per realization. This number of realizations was found to reach a statistically significant sample size during experimentation. Ground truth was labeled for each trial of each realization by a user who was asked to maintain preference for the entire realization. All machine models began each realization with a cold start, meaning that all classifiers and uncertainty models begin the first trial of each realization with no training data. As discussed in Section 6.1, the classifier used for machine placement disregards all training prior to the 6 most recent trials, as this improved the accuracy of machine placement. The baseline uncertainty model did not implement this type of forgetting.

### 8. Results

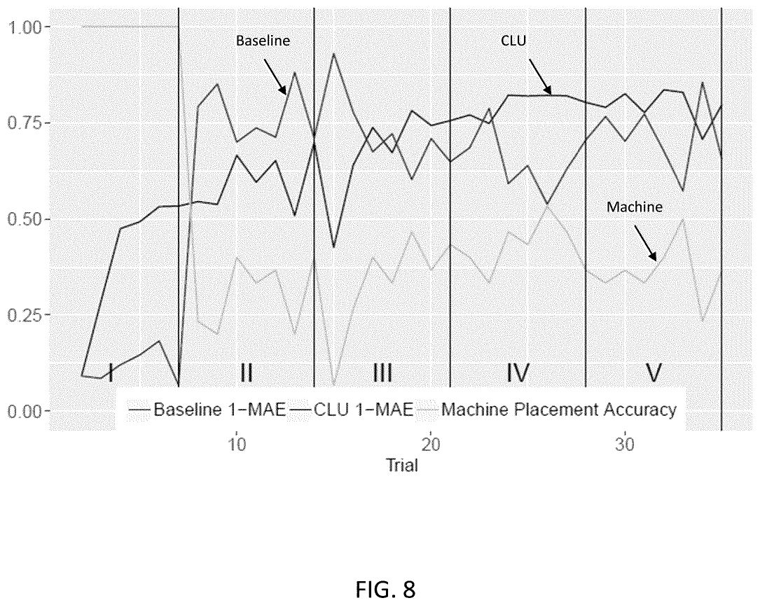

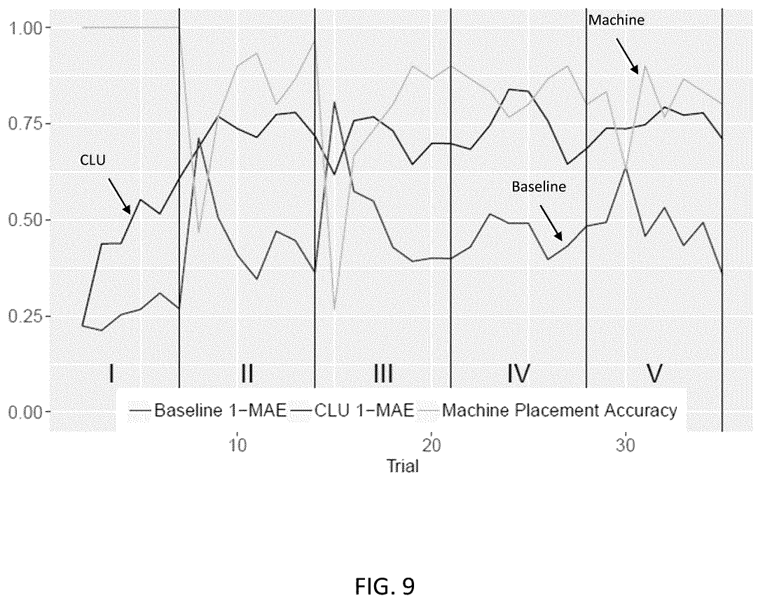

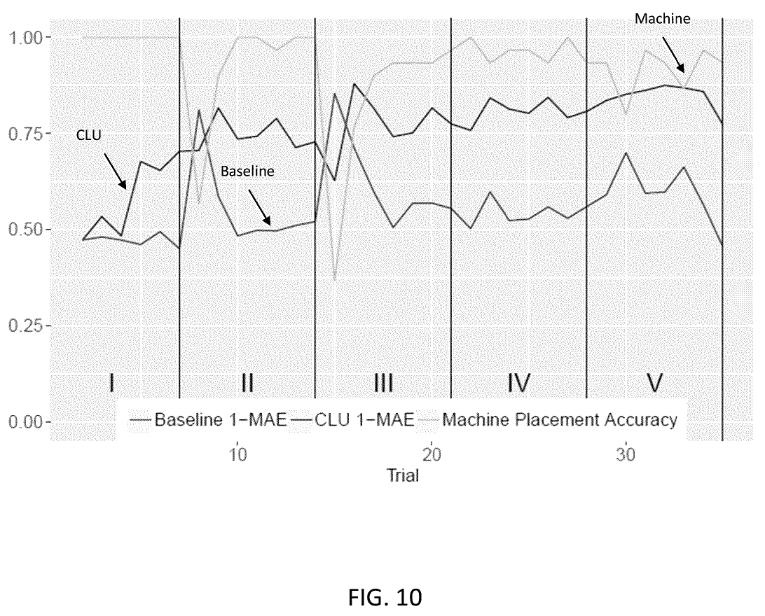

FIGS. 8-10 show the average results across all realizations for tolerances 0.02, 0.1, and 0.2 individually. The plots include the machine placement accuracy for reference. These particular plots are chosen as they compare and contrast the models for situations where machine placement accuracy is expected to be low (T=0.02), moderate (T=0.1), and high (T=0.2).

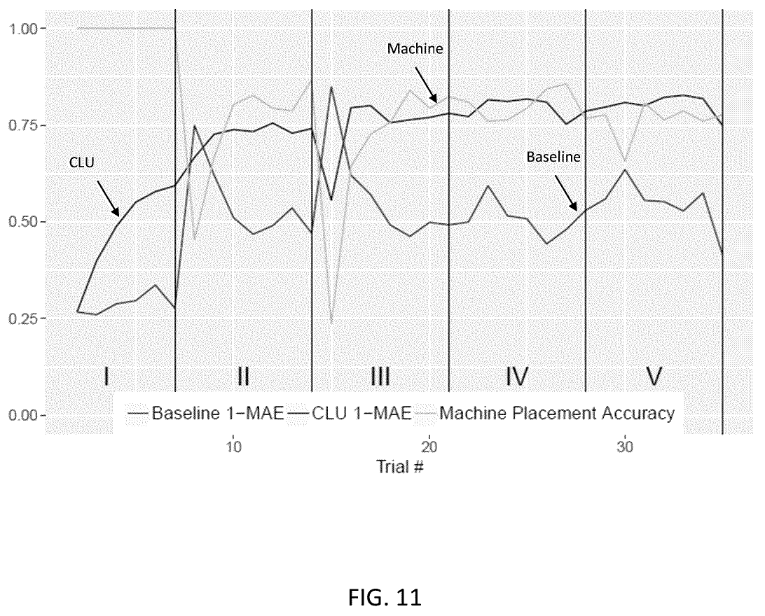

The baseline model (the red line) dramatically under performs during phase I when the machine placement accuracy is at 100 percent, due to the features acting discrete for this phase, while Gaussian naive Bayes performs best for continuous normally distributed features. As shown in the results, the CLU model significantly improves upon the baseline in almost every trial. The most noticeable trials where the baseline performs better than CLU are the first trials of Phases II and III. There are two important reasons why this behavior is observed. First, the baseline model for uncertainty tends to be biased towards underconfidence, meaning that its reported probability of correctness tends to be much less than the machine placement accuracy in general. This is also true for higher values of tolerance, where classifier accuracy is expected to be high. Because Phases II and III induce a relatively high amount of concept drift, the machine placement accuracy suffers greatly in the first trial of these phases. As the baseline is biased towards underconfidence, any significant fall in accuracy will cause it to exhibit a higher 1−MAE. The second reason that the baseline model outperforms CLU in these particular trials is CLU is unable to detect concept drift from first-class features of the data. As it is driven by feedback of correctness, it must observe that its current policy is inaccurate by observing that the incorrect machine placement was corrected by the human after entering a new phase of drift. However, as the machine placement accuracy improves incrementally in the subsequent trials of Phases II and III, the CLU model is able to very quickly outperform the baseline by accounting for the baseline's underconfidence by taking into account the incorrect machine placements. Phases IV and V do not generally induce as much concept drift, as indicated by the machine placement accuracy of those trials. Additionally, 1−MAE for CLU in Phase I, which is the simplest phase where machine placement is 100% accurate, is lowest among all phases. This is mainly due to the lack of training information from cold start as well as the fact that the bias of the baseline continues to decrease in this phase, undoing the adjustment of the CLU algorithm. FIG. 11 shows results for each trial averaged across all tested tolerances.

Mean and variance of precision of confidence for various tolerances are shown in Table 1. These values were calculated across all trials of all realizations of experiments. As shown, CLU is able to improve upon the baseline model by up to 67% and exhibited a 46% average improvement overall. In general, better CLU performance trended towards tolerance values of 0.06-0.16, where the machine placement accuracy was expected to be moderate and the baseline performed most poorly.

TABLE 1
1 - MAE for CLU and Baseline models. The mean and variance across
all trials and realizations for several tolerances are shown.

| 1 - MAE | |
|---|---|
| CLU | Baseline |

| Tolerance | Mean | Variance | Mean | Variance |
|---|---|---|---|---|
| 0.02 | 0.663 | 0.03 | 0.609 | 0.0614 |
| 0.04 | 0.701 | 0.0274 | 0.507 | 0.0382 |
| 0.06 | 0.701 | 0.0276 | 0.444 | 0.0241 |
| 0.08 | 0.715 | 0.0268 | 0.427 | 0.0202 |
| 0.1 | 0.686 | 0.0161 | 0.44 | 0.0167 |
| 0.12 | 0.73 | 0.0162 | 0.463 | 0.0154 |
| 0.14 | 0.746 | 0.0143 | 0.485 | 0.0127 |
| 0.16 | 0.733 | 0.0136 | 0.509 | 0.0116 |
| 0.18 | 0.735 | 0.014 | 0.537 | 0.0105 |
| 0.2 | 0.757 | 0.011 | 0.56 | 0.00898 |

The question of the convergence of CLU to well calibrated probabilities is difficult to answer. We know that Q-learning converges to the optimal action-values provided state-action values are repeatedly sampled, and that the state-action space is discrete (Watkins and Dayan, 1992). What this means is that CLU will converge to an optimal policy that guarantees the highest possible reward, however this is heavily dependent on our definition of the MDP. If the MDP is defined in such a way that gives higher rewards for a poorer performing uncertainty model, then the result will be CLU converging to poor uncertainty values, and furthermore if the reward function is essentially set equal to a random value, then the number of trials needed to converge will be prohibitively large. In addition, if the state action space is poorly defined, too large, or even too small (as demonstrated in section 6.5), the performance of CLU suffers and the convergence to the optimal policy slows. In addition, the question of whether CLU converges may be dependent on the choice for the baseline uncertainty model. There are several other baseline models that could be conceived that would benefit from the methods imbedded in CLU, however it is also possible to conjure up a baseline model that in no way benefits from CLU. That being said, we have not yet found a baseline model that is adversely affected by CLU. It is however the view of the researchers that, given a properly defined MDP, CLU has the potential to converge to well-calibrated uncertainty values for a wide variety of baseline uncertainty models.

### Alternative Baseline Models

One question that arises from this research is how other types of baseline models perform alongside CLU. In order to investigate this, we tried three different baseline models. This was done not only to check assumptions of the naive Bayes baseline model by drawing comparisons, but also to investigate the extent to which CLU can be used to improve a traditional uncertainty model. In the KDE model we investigated a Kernel Density Estimation (KDE) technique for the distributions used to calculate the posterior probabilities in naive Bayes. This method, as discussed in section 4, provides a useful means for which to convert distributions from discrete variables into continuous probability distributions. The Induction Model calculates confidence of each machine placement by equating it to the accuracy of the previous trial. What this means is that if the previous trial had a correct placement (i.e. one in which the machine placement is within a tolerance of the human placement), then the confidence value of the current trial is 1, and if the previous trial had an incorrect placement then the confidence value of the current trial is 0. A constant model, in which all confidence values are set to 0.5, was used as a means to test the basic assumption that the NB model can provide more information about the uncertainty than assuming the odds of a correct classification was a coin flip. In addition, we will see that this model provides evidence that CLU can operate as a stand-alone uncertainty model.

It should be noted that the parameters set during the sensitivity analysis discussed in section 6.5 are held fixed throughout this process of testing other baselines. In practice, once baseline model is chosen, a new sensitivity analysis should be conducted.

### Kernel Density Estimation

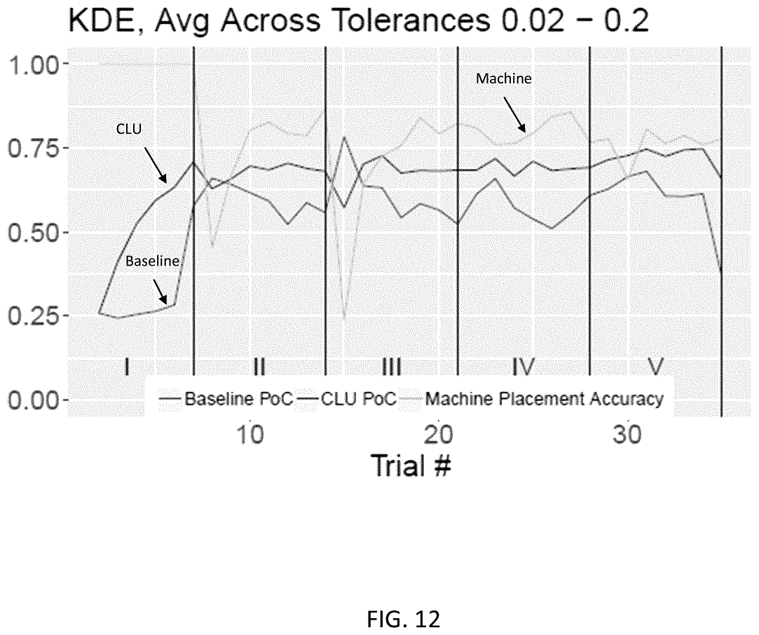

FIG. 12 shows results as shown in FIG. 11, but using KDE as the baseline uncertainty model. The advantage to using KDE is it allows for a way to interpret discrete variables in a continuous fashion, which is particularly advantageous in the early phases of each realization where there is much less complexity.

We can see that in FIG. 12 KDE out performs, in some trials, the Gaussian naive Bayes model described in section 6.1, however the CLU model performed somewhat worse. That being said, CLU does still make a noticeable improvement to the baseline in this case, which further gives evidence to the power of CLU.

### Induction

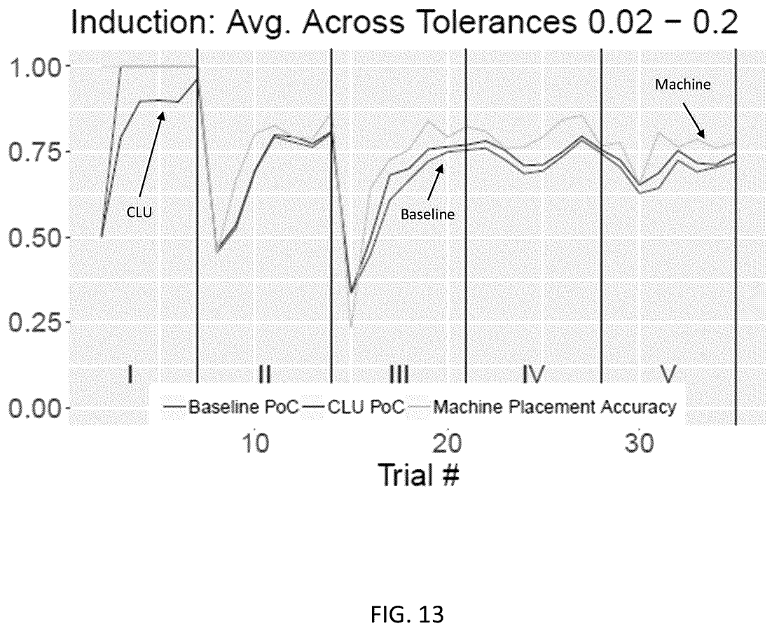

FIG. 13 shows results as shown in FIG. 11, but using induction as the baseline uncertainty model. We define an induction baseline uncertainty model as one in which the value for confidence is defined as 1 if the previous trial had a correct classification, and a 0 if the previous trial had an incorrect classification. That is,

$${C}_{t} = \{ \begin{matrix}1 & if {p}_{t - 1} = 1 \\ 0 & if {p}_{t - 1} = 0\end{matrix} \qquad ( 20 )$$

In practice, there is always a probability of an incorrect classification that is neither 0 nor 1. As a result, this model is inherently either as over confident as possible, or as under confident as possible. The motivation for this model was to see if a baseline that gave no information about the present trial was still capable of being improved upon using CLU. We can see from FIG. 13 that this baseline model results in confidence values that are highly susceptible to concept drift, as we can see at the start of phases II and III. This is likely due to the fact that, as per equation 20, confidence is a function of the accuracy of the classifier. In addition, we can see that CLU does not do much in the way of improving the performance. In fact, the induction model slightly out performs CLU in phase I (while CLU warms up), and from then on CLU and this baseline stay pretty much on par with one another. However, it is possible that CLU could begin to outperform the baseline if there were a higher number of trials in each phase. One possible reason for this is the fact that this baseline does not indicate much information in our definition of the state space. It is not clear whether or not a model similar to CLU could still improve upon this induction baseline if there is a reformulation of the state space to include information that is not encoded in successive baseline confidence values.

### Constant

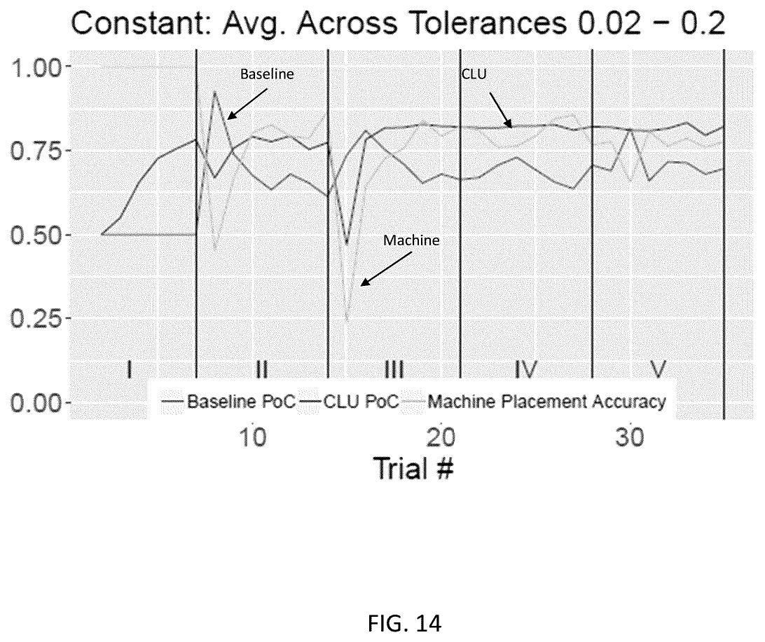

FIG. 14 shows results as shown in FIG. 11, but using the constant model as the baseline uncertainty model.

A baseline model that assumes every classification has a confidence of 0.5 is essentially equivalent to assuming the classification is as good as a coin flip. This model was used as a baseline, because we began to wonder about the implications of some of the baseline confidence values below 0.5 found using the Gaussian naive Bayes model. In FIGS. 8-11, during phase I the confidence values are quite low, however this is also the phase where the classifier performed at essentially perfect accuracy. Intuitively, this makes little sense, which is what motivated this constant baseline model. We can see from FIG. 14 that in this case CLU does in fact outperform the baseline. This suggests that CLU could operate as a relatively decent uncertainty model, without having the advantage provided by a nuanced baseline model.

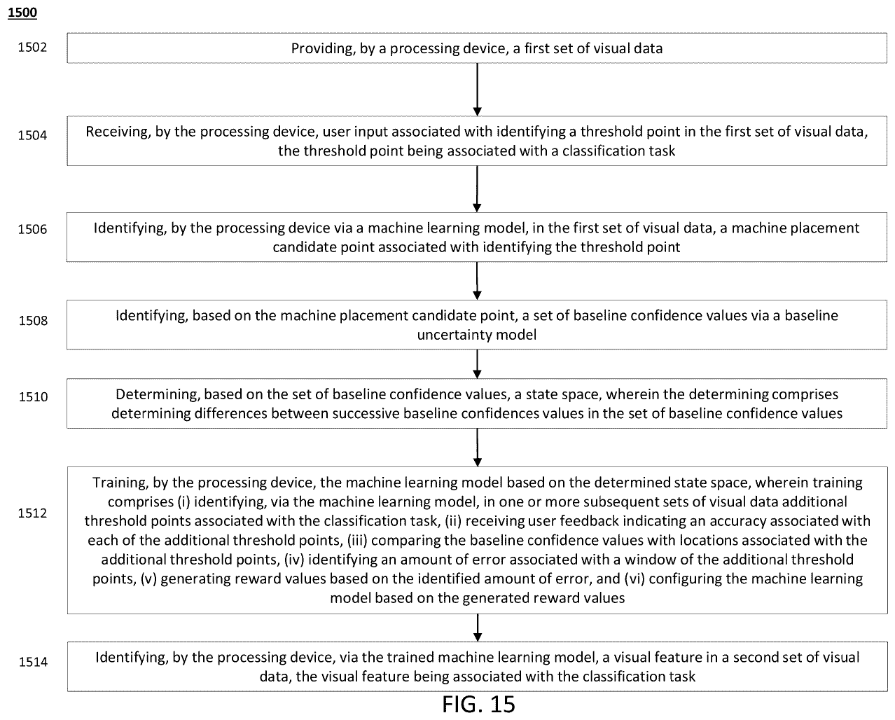

FIG. 15 illustrates an example method 1500, in accordance with one or more disclosed aspects. For example, method 1500 associated with a machine learning model and may include one or more steps. Step 1502 may include providing, by a processing device, a first set of visual data. Step 1504 may include receiving, by the processing device, user input associated with identifying a threshold point in the first set of visual data, the threshold point being associated with a classification task. Step 1506 may include identifying, by the processing device via a machine learning model, in the first set of visual data, a machine placement candidate point associated with identifying the threshold point. Step 1508 may include identifying, based on the machine placement candidate point, a set of baseline confidence values via a baseline uncertainty model. Step 1510 may include determining, based on the set of baseline confidence values, a state space, wherein the determining comprises determining differences between successive baseline confidences values in the set of baseline confidence values. Step 1512 may include training, by the processing device, the machine learning model based on the determined state space, wherein training comprises (i) identifying, via the machine learning model, in one or more subsequent sets of visual data additional threshold points associated with the classification task, (ii) receiving user feedback indicating an accuracy associated with each of the additional threshold points, (iii) comparing the baseline confidence values with locations associated with the additional threshold points, (iv) identifying an amount of error associated with a window of the additional threshold points, (v) generating reward values based on the identified amount of error, and (vi) configuring the machine learning model based on the generated reward values. Step 1514 may include identifying, by the processing device, via the trained machine learning model, a visual feature in a second set of visual data, the visual feature being associated with the classification task. One or more steps may be repeated, added, modified, and/or excluded.

According to some aspects, one or more disclosed embodiments may have one or more specific applications. According to some aspects, disclosed embodiments may be used to calibrate an uncertainty model involved in machine learning (ML) where there is human feedback. Examples of ML models that may be calibrated using CLU include classification problems like logistic regression or decision trees, the loss function used in backpropagation in a neural network, the error in regression analysis, and/or the like. For example, as described herein disclosed embodiments may be used to calibrate an uncertainty model for a Naive Bayes classification problem. Some examples of the applications of ML include region digitization, large language models, signal processing, and/or the like. According to some aspects, one or more disclosed aspects may be used to facilitate a water-based operation. In some cases, disclosed aspects may provide information (e.g., identification of a shore line, water-based interfaces, land/water interfaces, air/water/land interfaces, other interfaces, transitions, regions, objects, etc. in images, and/or the like), and in some cases the additional information may be used for search & rescue, for safety of navigation, for military situational awareness, for implementing and/or developing a mission route plan associated with operating a vehicle, aircraft, vessel, and/or the like. In some cases, one or more disclosed aspects may be used to facilitate a strategic operation, which can include a defensive tactical operation or naval operation.

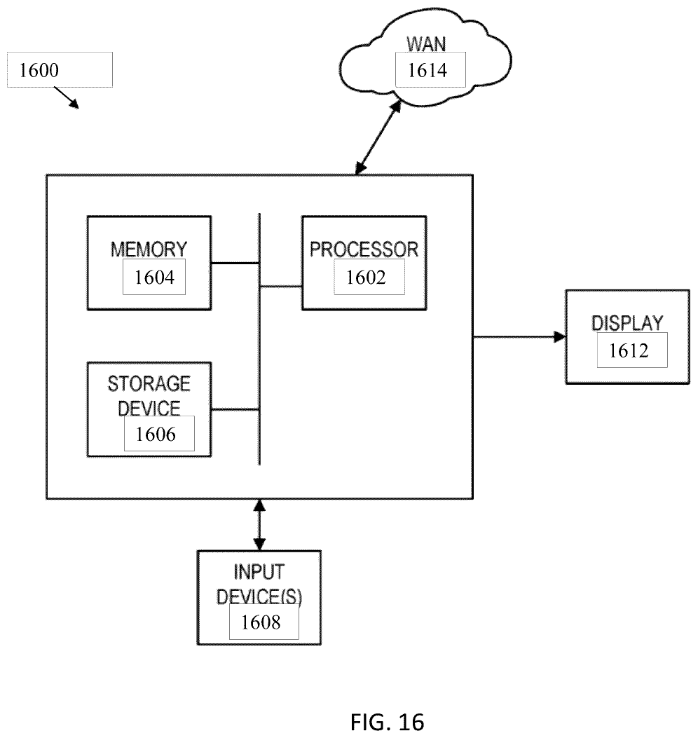

One or more aspects described herein may be implemented on virtually any type of computer regardless of the platform being used. For example, as shown in FIG. 16, a computer system 1600 includes a processor 1602, associated memory 1604, a storage device 1606, and numerous other elements and functionalities typical of today's computers (not shown). The computer 1600 may also include input means 1608, such as a keyboard and a mouse, and output means 1612, such as a monitor or LED. The computer system 1600 may be connected to a local may be a network (LAN) or a wide may be a network (e.g., the Internet) 1614 via a network interface connection (not shown). Those skilled in the art will appreciate that these input and output means may take other forms.

Further, those skilled in the art will appreciate that one or more elements of the aforementioned computer system 1600 may be located at a remote location and connected to the other elements over a network. Further, the disclosure may be implemented on a distributed system having a plurality of nodes, where each portion of the disclosure (e.g., real-time instrumentation component, response vehicle(s), data sources, etc.) may be located on a different node within the distributed system. In one embodiment of the disclosure, the node corresponds to a computer system. Alternatively, the node may correspond to a processor with associated physical memory. The node may alternatively correspond to a processor with shared memory and/or resources. Further, software instructions to perform embodiments of the disclosure may be stored on a computer-readable medium (i.e., a non-transitory computer-readable medium) such as a compact disc (CD), a diskette, a tape, a file, or any other computer readable storage device. The present disclosure provides for a non-transitory computer readable medium comprising computer code, the computer code, when executed by a processor, causes the processor to perform aspects disclosed herein.

Embodiments for machine learning methods and systems been described. Although particular embodiments, aspects, and features have been described and illustrated, one skilled in the art may readily appreciate that the aspects described herein are not limited to only those embodiments, aspects, and features but also contemplates any and all modifications and alternative embodiments that are within the spirit and scope of the underlying aspects described and claimed herein. The present application contemplates any and all modifications within the spirit and scope of the underlying aspects described and claimed herein, and all such modifications and alternative embodiments are deemed to be within the scope and spirit of the present disclosure.

### REFERENCES

Abdar. M., Pourpanah, F. Hussain, S., Rezazadegan. D., Liu, L., Ghavamzadeh, M., Fieguth, P., Cao, X., Khosravi. A., Acharya., U. R., et al. (2021). A review of uncertainty quantification in deep learning: Techniques, applications and challenges. Information Fusion, 76:243-297.
Aggarwal, (C. C., Kong, X., Gu. Q., Han, J., and Philip, S. Y. (2014). Active learning: A survey, In Data Classification, pages 599-634 Chapman and Hall/CRC.
Bellemare, M. G., Dabney, W., and Munos, R. (2017). A distributional perspective on reinforcement learning. In International Conference on Machine Learning, pages 449-458. PMLR.
Bhatt, U., Antorán, J., Zhang, Y., Liao, Q, V., Sattigeri, P., Fogliato, R., Melancçon, G., Krishnan, R., Stanley, J., Tickoo, O., et al. (2021). Uncertainty as a form of transparency: Measuring, communicating, and using uncertainty. In Proceedings of the 2021 AAAI/ACM Conference On AI, Ethics, and Society, pages 401-413.
Clements, W. R., Van Delft, B., Robaglia, B, -M., Slaoui, R. B., and Toth, S. (2020). Estimating risk and uncertainty in deep reinforcement learning. In Uncertainty and Robustness in Deep Learning Workshop at International Conference on Machine Learning.
Du, L., Song, Q., and Jia, X. (2014). Detecting concept drift: an information entropy based method using an adaptive sliding window. Intelligent Data Analysis, 18(3):337-364.
Fails, J. A. and Olsen Jr, D. R. (2003). Interactive machine learning. In Proceedings of the 8th international conference on Intelligent user interfaces, pages 39-45.
Guo, C., Pleiss, G., Sun, Y., and Weinberger, K. Q (2017), On calibration of modern neural networks, In International conference on machine learning, pages 1321-1330. PMLR.
Hasselt, H. V. (2012). Reinforcement learning in continuous state and action spaces. In Reinforcement learning, pages 207-251. Springer.
Hora, S. C. (1996). Aleatory and epistemic uncertainty in probability elicitation with an example from hazardous waste management. Reliability Engineering & System Safety, 54(2-3):217-223.
Hüllermeier, E. and Waegeman, W. (2021). Aleatoric and epistemic uncertainty in machine learning: An introduction to concepts and methods. Machine Learning, 110(3):457-506.
Jiang, H., Kim, B., Guan, M., and Gupta, M. (2018). To trust or not to trust a classifier. Advances in neural information processing systems, 31.
Jiang, L., S., and Chen, C. (2019). Recent research advances on interactive machine learning. Journal of Visualization, 22(2):401-417.
John, G. H. and Langley, P. (2013). Estimating continuous distributions in bayesian classifiers. arXiv preprint arXiv:1302.4964.
Kabra, M., Robie, A. A., Rivera-Alba, M., Branson, S., and Branson, K. (2013). Jaaba: interactive machine learning for automatic annotation of animal behavior. Nature methods, 10(1):64-67.
Kaplan, L., Cerutti, F., Sensoy, M., Preece, A. D., and Sullivan, P. (2018). Uncertainty aware ai ml: Why and how.
Kläs, M. and Vollmer, A. M. (2018). Uncertainty in machine learning applications: A practice-driven classification of uncertainty. In International conference on computer safety, reliability, and security, pages 431-438, Springer.
Krawczyk, B. and Wozniak, M. (2015). Weight naive bayes classifier with forgetting for drifting data streams. In 2015 IEEE International conference on systems, man, and cybernetics, pages 2147-2152. IEEE.
Li, M. and Sethi, I. K. (2006). Confidence-based active learning. IEEE transactions on pattern analysis and machine intelligence, 28(8):1251-1261.
Lu, J., Liu, A., Song. Y., and Zhang, G. (2020). Data-driven decision support under concept drift in streamed big data. Complex & Intelligent Systems, 6(1):157-163.
Michael, C.J., Acklin, D., and Scheuerman, J. (2020). On interactive machine learning and the potential of cognitive feedback. arXiv preprint arXiv:2003.10365
Michael, C. J., Dennis, S. M., Maryan, C., Irving, S., and Palmsten, M. L. (2019). A general framework for human-machine digitization of geographic regions from remotely sensed imagery, pages 259-268.
Mnih, V., Kavukeuoglu, K., Silver, D., Graves, A., Antonoglou, l., Wierstra, D., and Riedmiller, M. (2013). Playing atari with deep reinforcement learning. arXiv preprint arXiv:1312.5602.
Monarch, R. M. (2021). Human-in-the-Loop Machine Learning: Active learning and annotation for human-centered Al. Simon and Schuster.
Mosqueira-Rey, E., Hernández-Pereira, E., Alonso-Rios, D., Bobes-Bascarãn, J., and Fernández-Leal, Á, (2022). Human-in-the-loop machine learning: a state of the art, Artificial Intelligence Review, pages 1-50.
Nikolov, N., Kirschner, J., Berkenkamp, F., and Krause, A (2018). Information-directed exploration for deep reinforcement learning. International Conference on Learning Representations (ICLR).
Pronk, V., Gutta, S. V., and Verhaegh, W. F. (2005). Incorporating confidence in a naive bayesian classifier. In International Conference on user Modeling, pages 317-326. Springer.
Provost, F. J., Fawcett, T., Kohavi, R., et al. (1998). The case against accuracy estimation for comparing induction algorithms. In ICML, volume 98, pages 445-453.
Sahindis, N. V. (2004). Optimization under uncertainty; state-of-the-art and opportunities. Computers & Chemical Engineering, 28(6-7):971-983.
Schlimmer J. C. and Granger, R. H. (1986). Incremental learning from noisy data. Machine learning, 1:317-354.
Sutton, R. S. and Barto, A. G. (1998). Reinforcement learning: an introduction mit press. Cambridge, MA, 22447.
Teso, S. and Vergari, A. (2022). Efficient and reliable probabilistic interactive learning with structured outputs.
Wang, G., Li, W., Aertsen, M., Deprest, J., Ourselin, S., and Vercauteren, T. (2019). Aleatoric uncertainty estimation with test-time augmentation for medical image segmentation with convolutional neural networks. Neuro-computing, 338:34-45.
Watkins, C. J. and Dayan, P. (1992). Q-learning. Machine learning, 8(3):279-292.
Zhang, H. (2004). The optimality of naive bayes, Aa, 1(2):3.

What is claimed is:

1. A method comprising:
providing, by a processing device, a first set of visual data;
receiving, by the processing device, user input associated with identifying a threshold point in the first set of visual data, the threshold point being associated with a classification task;
identifying, by the processing device via a machine learning model, in the first set of visual data, a machine placement candidate point associated with identifying the threshold point;
identifying, based on the machine placement candidate point, a set of baseline confidence values via a baseline uncertainty model;
determining, by the processing device, based on the set of baseline confidence values, a state space, wherein the determining comprises determining differences between successive baseline confidences values in the set of baseline confidence values;
training, by the processing device, the machine learning model based on the determined state space, wherein training comprises (i) identifying, via the machine learning model, in one or more subsequent sets of visual data additional threshold points associated with the classification task, (ii) receiving user feedback indicating an accuracy associated with each of the additional threshold points, (iii) comparing the baseline confidence values with locations associated with the additional threshold points, (iv) identifying an amount of error associated with a window of the additional threshold points, (v) generating reward values based on the identified amount of error, and (vi) configuring the machine learning model based on the generated reward values; and
identifying, by the processing device, via the trained machine learning model, a visual feature in a second set of visual data, the visual feature being associated with the classification task.

2. The method of claim 1, wherein providing the first set of visual data comprises displaying an image.

3. The method of claim 1, wherein providing the first set of visual data comprises displaying a graph.

4. The method of claim 1, wherein the baseline uncertainty model comprises a naive Bayes model.

5. The method of claim 1, wherein the classification task comprises identifying a boundary between a high value and a low value.

6. The method of claim 1, wherein the second set of visual data comprises an image.

7. The method of claim 1, wherein the second set of visual data comprises a graph.

8. The method of claim 1, wherein identifying the visual feature in the second set of visual data comprises identifying an edge between two regions in the second set of visual data.

9. The method of claim 1, further comprising determining one or more discretization values of differences between successive baseline confidences values in the set of baseline confidence values.

10. The method of claim 1, further comprising performing a water-based operation based on the identified visual feature in the second set of visual data.

11. The method of claim 1, wherein the visual feature is associated with an edge between two regions in the visual data.

12. The method of claim 1, wherein the classification task is a temporal-based task.

13. The method of claim 1, further comprising determining one or more tolerance values indicating a maximum distance a machine placement can be from a user placement to be deemed correct.

14. The method of claim 13, wherein determining the one or more tolerance values comprises calculating a mean absolute error.

15. The method of claim 13, wherein the one or more tolerance values range from 0.02 to 0.20.

16. The method of claim 1, wherein determining the state space comprises using a Markov Decision Process framework.

17. The method of claim 16, wherein the Markov Decision Process framework uses Q-Learning by estimating a reward value at a state action pair to find an optimal policy associated with the state space.

18. The method of claim 1, wherein generating reward values comprises using a reward function that produces high reward values responsive to producing confidence values that are on average closer to an accuracy of a classifier within the window.

19. The method of claim 18, wherein the accuracy of the classifier is based on precision feedback from a user.

20. The method of claim 1, further comprising improving the baseline confidence values by aligning a probability of accurate classification based on feedback from a user.

21. The method of claim 1, wherein the first set of visual data is streaming data.

22. The method of claim 1, wherein the second set of visual data is streaming data.
